(19) United States
(12) Patent Application Publication
(10) Pub. No.: US 2006/0158570 A1
(43) Pub. Date: Jul. 20, 2006

(54) Multi-tuner receiver having integrated channel lists

(75) Inventors: Gaurav Arora, Northborough, MA (US); Ramanathan Meenakshisundaram, Waltham, MA (US); Sheau Ng, Wayland, MA (US)

Correspondence Address: VEDDER PRICE KAUFMAN & KAMMHOLZ, 222 N. LASALLE STREET, CHICAGO, IL, 60601, US

(73) Assignee: ATI Technologies Inc., Thornhill (CA)

(21) Appl. No.: 11/035,514

(22) Filed: Jan. 14, 2005

(51) Int. Cl. H04N 3/27; H04N 5/50

(52) U.S. Cl. 348/731; 348/732; 348/554

(57) ABSTRACT

A tuning module in a multi-tuner receiver stores channel parameters for tuning of channels within a channel list. Channels are tuned sequentially by the tuning module in response to channel advance (up/down) signals. Such signals may be provided by a central processor/controller. If a channel advance signal would cause the tuning module to advance past the beginning or end of the channel list, the module generates a list complete signal. The processor/controller may react accordingly. For example, the central processor/controller may disable a currently active tuning module and enable another tuning module/tuner in response to the list complete signal.

### FIELD OF THE INVENTION

The present invention relates generally to media receivers, and more particularly to media receivers having multiple tuners and integrated channel lists.

### BACKGROUND OF THE INVENTION

With the advent of an ever increasing number of sources of media, many modern electronic media receivers are capable of tuning media from such multiple sources. For example, some newer televisions and television set-top boxes are capable of receiving terrestrial broadcast, cable and satellite video and audio in multiple formats. Such formats may include broadcast NTSC/PAL television signals, radio signals, newer high definition ATSC television signals, quadrature amplitude modulated (QAM) digital cable signals, and the like. As well, some receivers are able to receive live, or on-demand, video or audio provided by way of data network, such as the internet.

In order to accomplish this, the receivers typically include multiple physical tuners: one to tune each signal type that the receiver is capable of receiving or tuning. Typically, tuners are added by way of tuning modules. Often such multiple tuning modules function independently. Each is capable of tuning, receiving and/or demodulating only one type of signals, from a particular source. A common output stage may present tuned video and/or audio to a monitor or other display, and audio amplifier, decoder or the like.

However, at present, tuners are not well integrated requiring end users to switch between the multiple tuners in order to select programs to be tuned. For most users, this is cumbersome and somewhat awkward.

Accordingly, there remains a need for a multi-media receiver including multiple tuners, whose tuning is integrated and user friendly.

### SUMMARY OF THE INVENTION

Exemplary of the present invention, a tuning module in a multi-tuner receiver stores channel parameters for tuning of channels within a channel list. Channels are tuned sequentially by the tuning module in response to channel advance (up/down) signals. Such signals may be provided by a central processor/controller. If a channel advance signal would cause the tuning module to advance past the beginning or end of the channel list, the module generates a list complete signal. The processor/controller may react accordingly. For example, the central processor/controller may disable a currently active tuning module and enable another tuning module/tuner in response to the list complete signal.

In accordance with an aspect of the present invention, there is provided a method of controlling first tuner and second tuner within a receiver, the first tuner formed on a first tuning module of the receiver, the first tuning module storing parameters for at least one tuneable channel in a channel list, the method including: providing a channel advance signal to the first tuning module, to advance to a next tuned channel; in response to providing the channel advance signal, receiving from the first tuning module a signal indicative of reaching the end of its channel list; in response to the signal indicative of reaching the end of its channel list, disabling the first tuning module and providing output from the second tuner.

In accordance with another aspect of the present invention, there is provided a multi-tuner receiver including: a first tuning module, storing a first list of tuning parameters for tuning the first tuning module to a plurality of channels, wherein the tuning module advances channels in accordance with the first list; and a second tuning module, storing a second list of tuning parameters for tuning the second tuning module to a plurality of channels, wherein the tuning module advances channels in accordance with the second list. There is also included a central controller for providing channel advance signals to the first and second tuning modules; the first tuning module operable to pass to the central controller a completion signal indicating a channel advance signal to the first tuning module would cause the first tuning module to advance beyond the beginning or end of the channel list.

In accordance with yet another aspect of the present invention, there is provided a multi-tuner media receiver, including: a first tuning module storing a first list of tuneable channels and tuning parameters for the first tuning module in a first channel list; a second tuner; memory storing a second list of tuneable channels and tuning parameters for the second tuner in a second channel list. There is also included means for providing a channel advance signal to the first tuning module, to advance to a next tuned channel within its channel list; and means for disabling the first tuning module, and enabling the second tuner to provide tuned output in response to receiving from the first tuning module a signal indicative of reaching the end of its channel list.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In figures which illustrate by way of example only, embodiments of the present invention,

FIG. 1 is a simplified schematic diagram of a multi-tuner receiver;

FIG. 2 is a flow diagram illustrating channel selection across multiple tuners in the receiver of FIG. 1;

FIGS. 3A and 3B are simplified schematic diagrams of multi-tuner receivers, exemplary of embodiments of the present invention;

FIG. 4 is a flow diagram illustrating channel selection across multiple tuners in the receiver of FIG. 3; and

FIGS. 5A-5B is a flow chart depicting steps performed at a receiver of FIG. 3A or FIG. 3B; and

FIG. 6 is a flow chart depicting alternate steps performed at a receiver of FIG. 3A or FIG. 3B.

### DETAILED DESCRIPTION

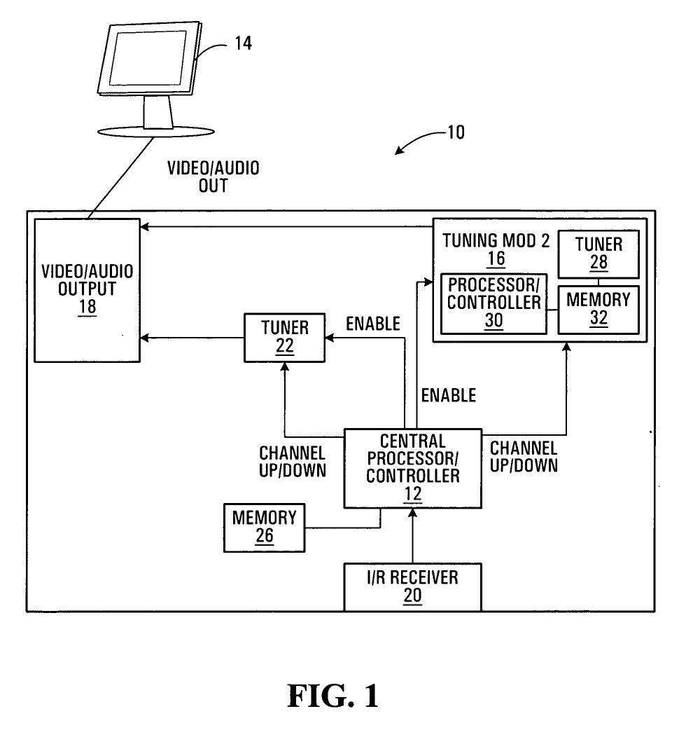

FIG. 1 is a simplified schematic block diagram of a conventional multi-tuner receiver 10. As illustrated, receiver 10 includes a plurality of tuners. In the depicted embodiment, receiver 10 includes one tuner 22, native to receiver 10 and a second, additional, tuner 28 forming part of tuning module 16. Each tuner 22, 28 is capable of tuning a received video or audio signal for provision to a video/audio output stage 18. In this context, tuning includes demodulating, decoding and/or receiving a signal.

Tuner 22 may, for example, be a conventional broadcast television tuner such as a NTSC/PAL tuner forming part of receiver 10. Tuning module 16 may be an expansion module including tuner 28 for receipt of over the air digital television signal, such as transmitted in accordance with the ATSC standard, digital cable or satellite television, or the like. Other tuners that could be used as part of receiver 10 include FM stereo tuners a digital audio broadcast tuner, an internet radio or video stream tuner, a direct digital network tuner capable of receiving a digital stream, such as an IEEE 1394 stream, or the like. Each such tuner could be added by way of a tuning module, like module 16.

Each tuner 22, 28 is capable of tuning a single channel from a selection of one or more available channels under control of a processor/controller. In the case of tuner 22, central processor/controller 12 in communication with memory 32 controls the tuning of tuner 22 by adjusting tuning parameters based on values stored within memory 26. In the case of tuner 28, a separate processor/controller 30 in communication with memory 32 both forming part of tuning module 16, controls the operation of tuner 28. Memory 32 stores parameters for multiple channels to be tuned by tuner 28. Typically, parameters for the multiple channels are organized as a sequence (or list) of tuneable channels. The parameters may, for example, be determined as the result of a configuration sequence used to assess available channels. Channels may also be added or re-ordered by an end user.

Tuner 22 may, for example, in the case of an NTSC tuning module, include a voltage controlled oscillator (VCO), a demodulator, an intermediate frequency stage, and the like (not specifically shown). The VCO causes the tuning module to tune to a desired channel within a range of broadcast frequencies. The VCO of the tuning module is controlled by central processor/controller 12 using values stored within memory 32.

Tuning module 16 is capable of tuning and demodulating or demultiplexing other types of modulated signals. As such, the tuning module includes a different tuner 28 capable of demodulating, demultiplexing or otherwise receiving and decoding signals in a different manner than tuner 22. Operating parameters of tuner 28 are controlled and adjusted by processor/controller 30 of tuning module 16.

Processor/controller 30 may be any suitable type of electronic controller, such as a microprocessor, micro-controller, digital signal processor or single or multi-purpose integrated circuit. Memory 32 and processor/controller 30 typically allow for the pre-programming of available parameters to allow tuner 28 to tune available channels. Tuner parameter settings for a list of channels are stored in memory 32 and may be accessed by processor/controller 30 to control tuner 28. Again, for example, if tuner 28 includes a VCO, tuning parameters may be VCO tuning frequencies for available channels.

Alternatively, if tuning module 16 is a direct digital network tuner module or other similar module, it may only be capable of tuning a single input. The channel list in such a case might therefore include a single entry or multiple entries.

Module 16 further includes an external channel advance input that causes processor/controller 30 of module 16 to load parameters of stored channels within memory 32, in sequence, into tuner 28 of module 16. Specifically, the external channel advance input, signals processor/controller 30 of module 16 to load tuning parameters corresponding to the next or previous channel within the list of channels for which parameters are stored.

In order to integrate the presence of separate tuners 22, 28 central processor/controller 12 may enable or disable tuning module 16 and tuner 22 by way of ENABLE signals, so that outputs of either tuner 22 or 28 is presented to video/audio output stage 18. Central processor/controller 12 is thus able to control whether tuning module 16 or tuner 22 provides output to video/audio output stage 18 and thereby which of the available signals are presented to video/audio outputs of output stage 18.

Video/audio output stage 18 in turn, provides a video and audio out signal capable of being viewed by a display device 14 in the form of a computing device, television device, home theatre, stereo, or the like. To this end video/audio output stage 18 may include a video/audio encoder producing a suitable video and audio output and optional video/audio modulators.

Externally, central processor/controller 12 may receive user input signals from a user interface. The interface may for example take the form of an infrared remote receiver 20 and remote control (not illustrated); a keypad forming part of multimedia receiver 10; or the like. In response to signals received from the user interface (e.g. at infrared receiver 20), central processor/controller 12 selects which of the tuners 22 or 28 should be enabled and provides channel advance signals to the enabled tuner. Thus, central processor/controller 12 effectively integrates the multiple tuners 22, 28.

However, as noted, tuning parameters representing channels to be tuned by tuner 22 are stored within memory 26 in communication with central processor/controller 12. Parameters representing channels to be tuned by tuner 28 are stored locally to module 16, for example in memory 32. Transition between channels on distinct tuners or lists is not integrated. Instead, tuning of channels tuned by one tuner (e.g. tuner 28 of module 16) requires explicit selection of that tuner or tuning module 16, while tuning of channels tuned by the other tuner (e.g. tuner 22) requires explicit selection of that tuner 22.

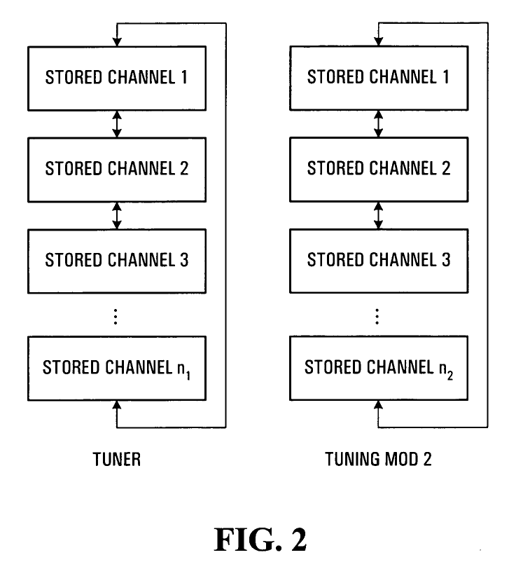

As such, as illustrated in FIG. 2 typical channel selection at tuner 22 cycles between channels for which parameters are stored within memory 26. Thus, parameters for stored channels are loaded sequentially within the tuner 22 in the stored order by processor/controller 12. Once the stored list of channels for tuner 22 is advanced beyond the last stored channel the sequence is cycled to the first channel within the sequence. Thus as the channels are advanced by central processor/controller 12, channels are advanced at tuner 22 sequentially from stored channel 1 to stored channel n₁ and back to stored channel 1.

Tuning module 16, when selected, similarly advances channels stored within memory of tuning module 16 from stored channels 1 to n₂ and back to stored channel 1, at tuner 28 as processor/central controller 12 provides channel advance signals to tuning module 16.

Thus, although receiver 10 includes two tuners, channel lists used by the tuners are not integrated. Although overall integration of channel lists by central processor/controller 12 may be desirable, this overall integration presents architectural difficulties and makes integration of independent tuners and tuning modules difficult.

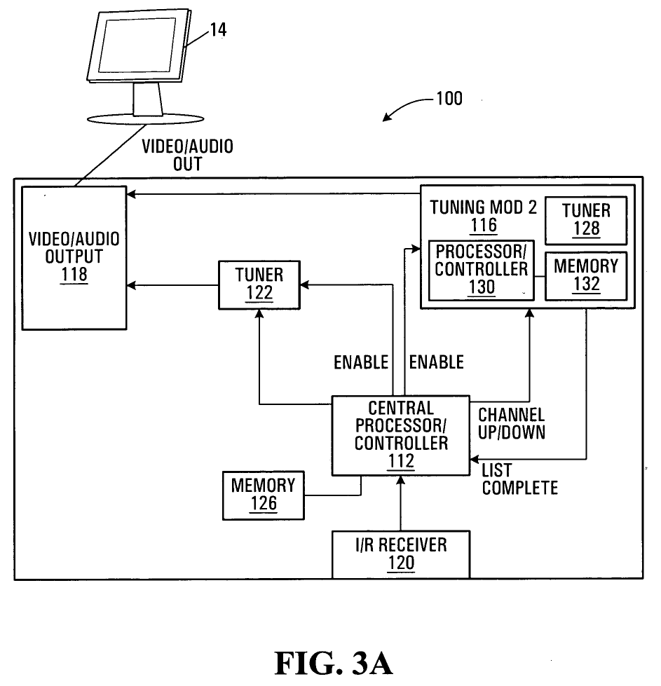

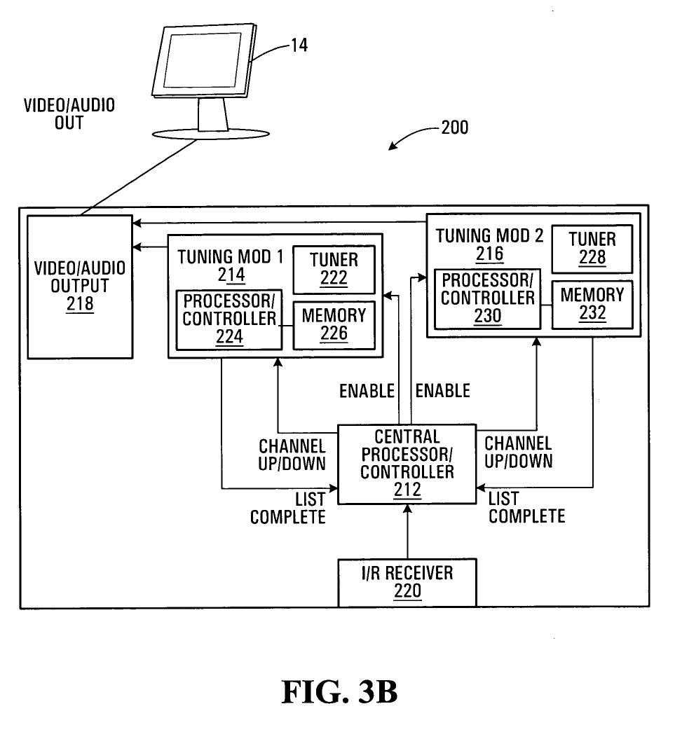

Accordingly, FIG. 3A illustrates an example multi-tuner receiver 100 exemplary of an embodiment of the present invention. Multi-tuner receiver 100 like receiver 10 (FIG. 1) includes a tuner 122 native to receiver 100, and a tuning module 116. Outputs of the tuner 122 and tuning module 116 are again provided to a video/audio output stage 118 (like video/output stage 18 of receiver 10). Channel tuning parameters for tuner 122 are stored within memory 126. Tuning module 116, like tuning module 16 includes its own tuner 128, processor/controller 130 and memory 132. Again, channel parameters for a list of one or more channels to be tuned by module 116 are stored within local memory 132 of those tuning module 116. Enable signals are again provided by central processor/controller 112 to enable tuning module 116 and select which of the tuning modules or tuner 122 is currently active and providing video/audio output to video/audio output stage 118. Similarly, channel advance (up/down) signals cause processor/controller 130 to load tuning parameters corresponding to tuning parameters corresponding to the previous or next channel in the associated sequence of channels for which parameters are stored within memory 132. Video/audio output stage 118 provides an output signal for presentation to an amplifier, video display 14, or the like. Once again processor/controllers 112, 130 may be formed as microprocessors, micro-controllers, digital signal processors, single or multi-purpose integrated circuits, or the like.

Unlike tuning modules 16 and tuner 22 of multi-tuner receiver 10 of FIG. 1, however, tuning module 116 provides list complete signals to the central processor/controller 112, when a channel advance signal would cause module 116 to advance past the end or beginning of the list of stored channels for tuning module 116, as detailed below.

Again, central processor/controller 112 provides a channel advance signal to tuning module 116 in response to inputs received at an external interface 120 which may again be an infrared receiver, keypad or the like. Channels of tuner 122 are advanced by central processors/controller 112 by loading channel tuning parameters from memory 126. Channels of tuner 128 of module 116 are advanced by having local processor 130 load channel tuning parameters from local memory 132. Parameters for n₁ and n₂ channels may be stored in memory 126 and memory 132 of tuning modules 116, respectively. However, once a channel-advance (up) signal is received by tuning module 116 requesting that a channel be advanced from the last channel of its list, or a channel advance (down) signal from the first channel in its sequence to the last channel in a list, a list complete signal is generated and provided to central processor/controller 112. Conveniently, a list complete signal (forward) and list complete (backward) signals are generated, so that central processor/controller 112 may react, as described below.

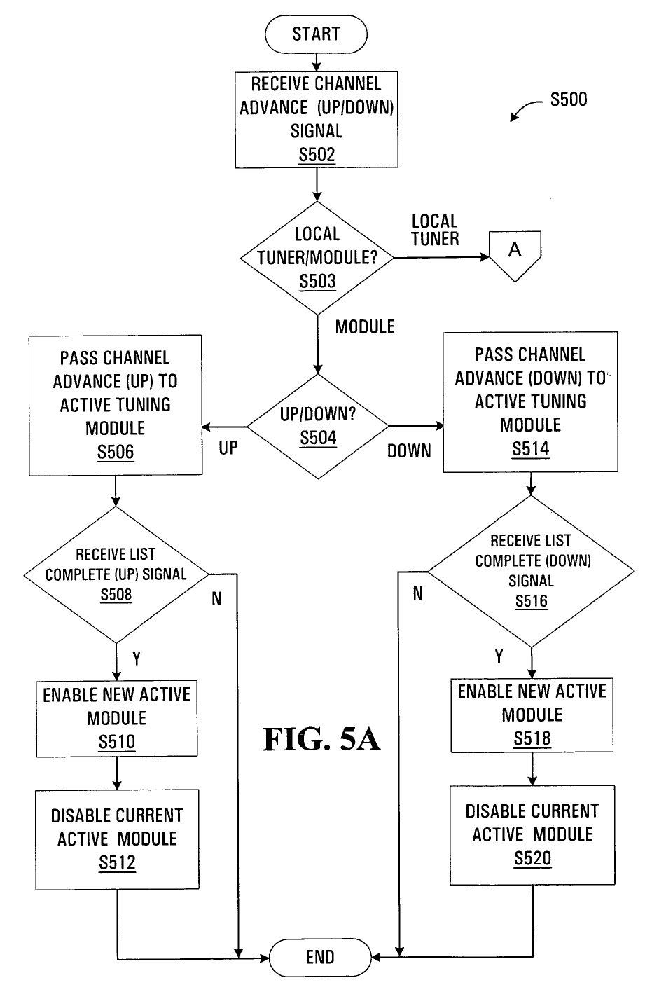

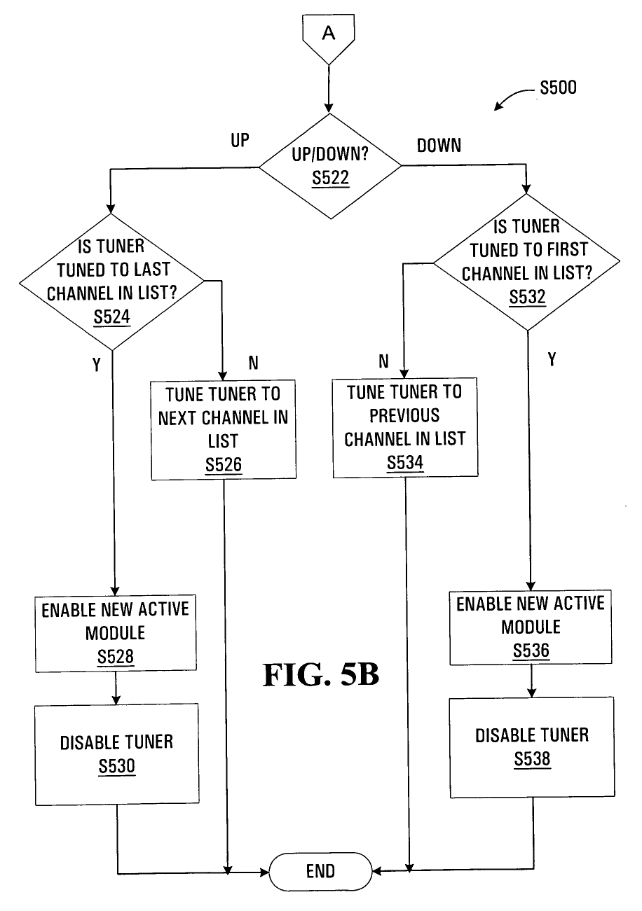

So, in operation, central processor/controller performs steps S500 depicted in FIGS. 5A and 5B. Processor/controller 112 receives an external channel advance command from interface 120 in step S502. As external tuning modules, such as module 116, are controlled slightly differently than local tuner 122, processor/controller 112 assesses whether the currently active tuner is local tuner 122 or a tuning module 116 in step S503. If the currently active tuner is local tuner 122, steps S522-S538 are performed. If the currently active tuner is on module 116 (or another module, not shown), steps S504-S520 are performed.

If the active tuner is on module 116 (as determined in step S503) and the command is a channel up command, as determined in step S504, central processor/controller 112, dispatches a corresponding channel advance (up) signal to tuning module 116 in step S506. If tuning module 116 would advance the channel past the end of its stored list, tuning module 116 generates a list complete (up) signal, which is received at processor/controller 112 in step S508. In response to receiving the list complete (up) signal from module 116, central processor/controller 112 enables the next logical tuning module or tuner 122 at the receiver in step S510 and disables the currently active tuning module 116 in step S512. Upon being enabled, the next tuning module/tuner is also tuned to the first stored channel within its list. Thereafter, any channel advance (up) signals to increment channels will increment channels according to the list associated with the now active tuning module.

If a channel advance (down) signal is received, as determined in step S504, central processor/controller 112 similarly dispatches a channel advance (down) signal to tuning module 116 in step S514. If tuning module 116 would advance the channel past the beginning of its stored list, tuning module 116 generates a list complete (down) signal, which is received at processor/controller 112 in step S516. In response to receiving the list complete (down) signal from module 116, central processor/controller 112 enables the previous logical tuning module or tuner at the receiver in step S518 and disables the currently active tuning module 116 in step S520. Upon being enabled, the next tuning module/tuner is also tuned to the last stored channel within its list.

If tuner 122 is active, as assessed in step S503, processor/controller 112 assesses if tuner 122 is tuned to the first or last (n₁^{th}) channel in its list in step S532 or S524, in case of a channel advance up or down signal, respectively. If the n₁^{th} channel has been reached (as determined in step S524) and a channel up command is received, tuner 122 is disabled in step S530 and module 116 (or the next logical module) is enabled in step S528. The newly enabled tuning module/tuner is tuned to the first channel in its associated channel list. Similarly, if tuner 122 is tuned to the first channel in its list of channels (as determined in step S532), and a channel down command is received, tuner 122 is disabled in step S538 and module 116 is enabled in step S536 and advanced to the last channel in its associated list. If the tuner 122 is not tuned to the first or last channel in its associated channel list, it is tuned to the next or previous channel in step S526 or S534, respectively.

As noted, after one tuner has been disabled, and another has been enabled, tuning will continue at the newly enabled tuner (i.e. tuner 128 at module 116 or tuner 122) at the beginning or end of the stored list for that tuner. For a tuning module 116 this may be accomplished by providing a channel advance (up) or channel advance (down) signal to the newly enabled module 116. For tuner 122, the tuning parameters for the first or last channel within the channel list for tuner 122 may be loaded by processor/controller 132.

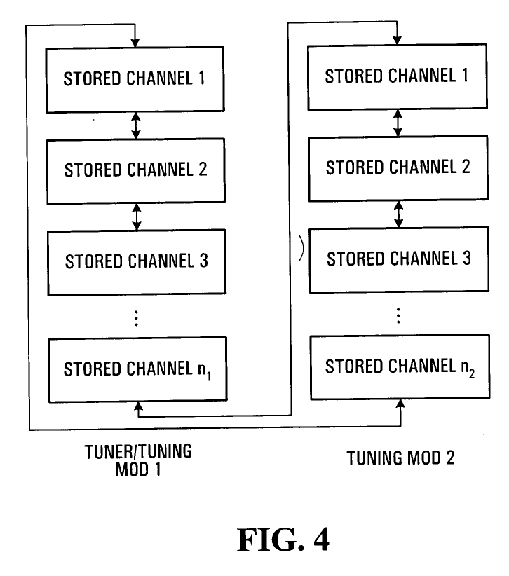

Thus, as illustrated in FIG. 4, the tuning lists stored within memory 126 and at tuning module 116 are effectively integrated into a single continuous list. Channels are advanced from one module and at the end of the channel list within one module to the channel list within a second module. An end-user now need not manually switch between tuning modules when channels are advanced.

As will be appreciated the depicted arrangement of the two tuners may be easily expanded to K tuners. To that end, FIG. 3B illustrates a receiver 200 including two tuners 222 and 228 each one contained in its own tuning module 214 and 216. Receiver 200 may or may not contain further tuner(s) like tuner 122 of receiver 100 that do not form part of a module. In any event, independent channel lists for each tuner 222 and 228 are stored within memories 226 and 232, local to their respective tuning modules. Local processors/controllers 224/230 load channel tuning parameters into tuners 222 and 228, respectively in response to channel advance (up/down) signals provided to modules 214 and 216 by processor 212 in response to channel commands received at interface 220. Again, channels are tuned in the order they are stored within channel lists within memories 226, 232. Processor/controllers 224/230, in response, provide channel list complete (up/down) signals to central processor 212 once a channel advance signal would cause a module to advance past the first or last channel. Central processor/controller 212 accordingly may switch from the first tuning module 214 to the second tuning module 216 each time the end of the stored channel list at the first tuning module is reached, as a result of a channel up (advance) signals. Similarly, the central processor/controller 212 would switch from the second tuning module 216 to the first tuning module 214 each time the channel is decremented beyond the first channel stored.

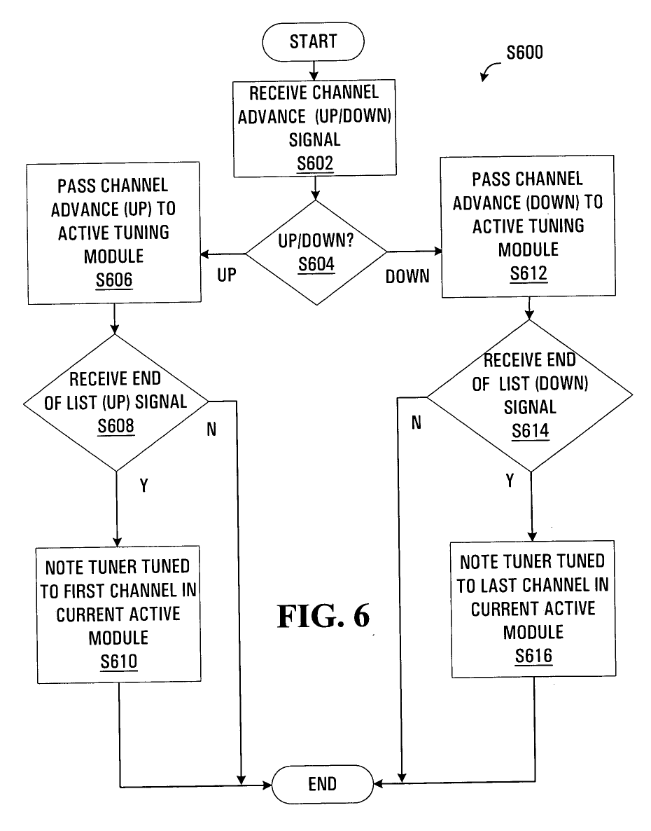

As will now be appreciated, provision of channel list complete signals allows central processor/controller 112 or 212 to integrate tuning modules in any arbitrary number of ways. For example, multiple channel lists may be tuned sequentially, as illustrated in FIGS. 5A and 5B. Of course, channels need not be tuned in this order. Channel lists could instead be tuned independently in a conventional manner. Any provided list complete signals could be ignored, or used by processor/controller 112 as an indicator that, if necessary, a tuning module should be provided with a further channel advance (up/down) signal in order to cause the module to advance past the beginning or end of the stored channel list to the beginning or end of the list. This is exemplified in FIG. 6. Whether or not receiver 100 or 200 operates as depicted in FIG. 5A or 5B, as illustrated in FIG. 6 or otherwise, could be end user selected. Additionally, central processor/controller 112 could control channel advancing between tuners in an arbitrary manner through the use of tuning parameters for all tuners at the receiver.

As will now also be appreciated, multi-tuner receiver 100 or 200 may be embodied using any number of conventional or custom components. For example, receiver 100 or 200 may be embodied using custom hardware, with module 116 or modules 214 and 216 each formed as a custom tuning module suitable for tuning/receiving a particular type of signal. Receiver 100 or 200 could be a set-top box, a receiver integrated with a monitor, or television, or the like. Receiver 100 or 200 could similarly be formed as a handheld device accommodating tuning modules and including an integrated display. Alternatively, receiver 100 may be formed as a multi-media computing device. Each of modules 116, 214, and 216 may, for example, be embodied as peripheral modules or cards in a computing device, interconnected with a central processing unit by a peripheral bus. List complete signals may be passed as data signals directly or indirectly across the peripheral bus.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A method of controlling first tuner and second tuner within a receiver, said first tuner formed on a first tuning module of said receiver, said first tuning module storing parameters for at least one tuneable channel in a channel list, said method comprising:
providing a channel advance signal to said first tuning module, to advance to a next tuned channel;
in response to providing said channel advance signal, receiving from said first tuning module a signal indicative of reaching the end of its channel list;
in response to said signal indicative of reaching the end of its channel list, disabling said first tuning module and providing output from said second tuner.

2. The method of claim 1, wherein said second tuner forms part of a second tuning module, and said method further comprises enabling said second tuning module and providing a channel advance signal to said second tuning module after receipt from said first tuning module of said signal indicative of reaching the end of its channel list.

3. The method of claim 2, wherein said first tuning module is capable of tuning at least one of analog television signals and digital television signals.

4. The method of claim 3, wherein said second module is capable of tuning at least one of analog television signals and digital television signals.

5. The method of claim 1, wherein said first tuning module is capable of tuning an IEEE 1394 digital stream.

6. The method of claim 1, wherein said channel advance signal provided to said first tuning module comprises a signal indicating said first tuning module is to advance to a next channel in its channel list.

7. The method of claim 1, wherein said list complete signal is received by way of a computer bus.

8. A multi-tuner receiver comprising:
a first tuning module, storing a first list of tuning parameters for tuning said first tuning module to a plurality of channels, wherein said tuning module advances channels in accordance with said first list;
a second tuning module, storing a second list of tuning parameters for tuning said second tuning module to a plurality of channels, wherein said tuning module advances channels in accordance with said second list;
a central controller for providing channel advance signals to said first and second tuning modules;
said first tuning module operable to pass to said central controller a completion signal indicating a channel advance signal to said first tuning module would cause said first tuning module to advance beyond the beginning or end of said channel list.

9. The receiver of claim 8, wherein said central controller is operable to disable said first tuning module in response to receiving a list complete signal from said first tuning module.

10. The receiver of claim 9, wherein said central controller is operable to enable said second tuning module in response to receiving said list complete signal from said first tuning module.

11. The receiver of claim 10, wherein said second tuning module is operable to pass to said central controller a list complete signal indicating a channel advance signal to said second tuning module would cause said second tuning module to advance beyond the beginning or end of said second channel list, and wherein said central controller is operable to disable said second tuning module and enable said first tuning module in response to receiving a list complete signal from said second tuning module.

12. The receiver of claim 8, wherein said first tuning module comprises one of an NTSC or PAL compliant television tuning module.

13. The receiver of claim 8, wherein said second tuning module comprises a digital television tuning module.

14. The receiver of claim 8, wherein said first tuning module comprises a tuner and a controller to load stored parameters from said first list to tune said first tuner.

15. The receiver of claim 14, wherein said central controller comprises a microprocessor.

16. The receiver of claim 14, wherein said central controller comprises a digital signal processor.

17. The receiver of claim 15, wherein said first and second tuning modules comprise expansion cards interconnected with an expansion bus of a computing device.

18. A multi-tuner media receiver, comprising:
a first tuning module storing a first list of tuneable channels and tuning parameters for said first tuning module in a first channel list;
a second tuner;
memory storing a second list of tuneable channels and tuning parameters for said second tuner in a second channel list;
means for providing a channel advance signal to said first tuning module, to advance to a next tuned channel within its channel list;
means for disabling said first tuning module, and enabling said second tuner to provide tuned output in response to receiving from said first tuning module a signal indicative of reaching the end of its channel list.
